(19) United States
(12) Patent Application Publication
(10) Pub. No.: US 2017/0253510 A1
(43) Pub. Date: Sep. 7, 2017

(54) METHOD AND SYSTEM OF WASTEWATER TREATMENT USING FACULTATIVE-ORGANISM-ADAPTED MEMBRANE BIOREACTOR

(71) Applicant: Jiangxi JDL Environmental Protection Co., Ltd., Nanchang (CN)

(72) Inventors: Zhimin LIAO, Nanchang (CN); Tao ZHOU, Nanchang (CN)

(21) Appl. No.: 15/604,627

(22) Filed: May 24, 2017

Related U.S. Application Data
(63) Continuation-in-part of application No. PCT/CN2015/091071, filed on Sep. 29, 2015.

(30) Foreign Application Priority Data
Sep. 1, 2015 (CN) 201510552160.1

(51) Int. Cl. C02F 3/12; C02F 3/00; C02F 1/44

(52) U.S. Cl. CPC C02F 3/1273; C02F 1/444; C02F 3/006; C02F 2209/001; C02F 2209/22

(57) ABSTRACT

A wastewater treatment system including a facultative-organism-adapted membrane bioreactor. The facultative-organism-adapted membrane bioreactor includes a reaction vessel, a membrane separation system, a water production system and an aeration system. The membrane separation system is disposed in the reaction vessel. The water production system communicates with the membrane separation system to pump a filtrate out of the membrane separation system. A wastewater treatment method using the facultative-organism-adapted membrane bioreactor includes: aerating the reaction vessel to enable a dissolved oxygen concentration in over 50% of the reaction vessel is smaller than 1 mg/L, a dissolved oxygen concentration in the membrane separation system is smaller than 2.0 mg/L, and a dissolved oxygen concentration in the reaction vessel excluding the membrane separation system to be greater than 0 and smaller than 1.0 mg/L.

### CROSS-REFERENCE TO RELATED APPLICATIONS

This application is a continuation-in-part of International Patent Application No. PCT/CN2015/091071 with an international filing date of Sep. 29, 2015, designating the United States, now pending, and further claims foreign priority benefits to Chinese Patent Application No. 201510552160.1 filed Sep. 1, 2015. The contents of all of the aforementioned applications, including any intervening amendments thereto, are incorporated herein by reference.

### BACKGROUND OF THE INVENTION

Field of the Invention

The invention relates to a method and system of wastewater treatment using a facultative-organism-adapted membrane bioreactor.

Description of the Related Art

Membrane bioreactor (MBR) is a biochemical reaction system mainly including a bioreactor, a membrane assembly, a water production system, an aeration system, and a sludge discharge system and a sludge return system. Disadvantages of MBR are as follows: 1) A large amount of sludge is produced and needs discharging. 2) The MBR consumes a large amount of energy. In order to scour the membrane and supply oxygen for aerobic organisms to degrade pollutants, a high-power blower is required. 3) The MBR is required to be controlled precisely around the clock to discharge and return sludge.

### SUMMARY OF THE INVENTION

In view of the above-described problems, it is one objective of the invention to provide a method and system of wastewater treatment using a facultative-organism-adapted membrane bioreactor.

To achieve the above objective, in accordance with one embodiment of the invention, there is provided a wastewater treatment system comprising a facultative-organism-adapted membrane bioreactor, the facultative-organism-adapted membrane bioreactor comprising: a reaction vessel, a membrane separation system, a water production system and an aeration system. The membrane separation system is disposed in the reaction vessel. The water production system communicates with the membrane separation system to pump filtrate out of the membrane separation system. The aeration system is employed to aerate the reaction vessel and the membrane separation system.

By controlling an aeration rate of the aeration system, a dissolved oxygen concentration in over 50% of the reaction vessel is greater than 0 and smaller than 1 mg/L, a dissolved oxygen concentration in the membrane separation system is greater than 0 and smaller than 2.0 mg/L, and a dissolved oxygen concentration in the reaction vessel excluding the membrane separation system is greater than 0 and smaller than 1.0 mg/L. The dissolved oxygen concentration in the membrane separation system is higher than the dissolved oxygen concentration in the reaction vessel excluding the membrane separation system.

In a class of this embodiment, the water production system optionally adopts a suction type water production system and a gravity flow type water production system.

In a class of this embodiment, the membrane separation system employs a microfiltration membrane or an ultrafiltration membrane.

In accordance with another embodiment of the invention, there is provided a method of wastewater treatment using the facultative-organism-adapted membrane bioreactor, the method comprising: aerating the reaction vessel to enable a dissolved oxygen concentration in over 50% of the reaction vessel to be greater than 0 and smaller than 1.0 mg/L, a dissolved oxygen concentration in the membrane separation system to be greater than and smaller than 2.0 mg/L, and a dissolved oxygen concentration in the reaction vessel excluding the membrane separation system to be greater than 0 and smaller than 1.0 mg/L; and controlling the dissolved oxygen concentration in the membrane separation system to be higher than the dissolved oxygen concentration in the reaction vessel excluding the membrane separation system.

In accordance with another embodiment of the invention, there is provided a method of upgrading a common membrane bioreactor into a facultative-organism-adapted membrane bioreactor, the common membrane bioreactor comprising a reaction vessel comprising separators and a front reaction zone, the method comprising:
1) demolishing the separators or the front reaction zone of the reaction vessel;
2) cutting down an aeration rate of a blower or reducing the arrangement of aeration pipes of an aeration system to enable a dissolved oxygen concentration in over 50% of the reaction vessel to be greater than 0 and smaller than 1.0 mg/L, a dissolved oxygen concentration in the reaction vessel excluding the membrane separation system to be greater than 0 and smaller than 2.0 mg/L, and a dissolved oxygen concentration in the reaction vessel excluding the membrane separation system to be greater than 0 and smaller than 1.0 mg/L; and controlling the dissolved oxygen concentration in the membrane separation system to be higher than the dissolved oxygen concentration in the reaction vessel excluding the membrane separation system; and
3) demolishing or stopping a sludge discharge system, a sludge return system and sludge treatment equipment.

Compared with existing technologies, advantages of the wastewater treatment method using the facultative-organism-adapted membrane bioreactor are as follows: the method reduces oxygen supply, saves aeration energy consumption (save more than 30% energy than the membrane bioreactor), and develops an organism system based on facultative anaerobic bacteria to efficiently degrade pollutants in the water. The wastewater treatment system by the facultative-organism-adapted membrane bioreactor is still in operation without sludge discharge. The sludge concentration in the reactor can self-adjust in accordance with the change of the inlet water concentration, and finally the system realizes dynamic equilibrium. The sludge discharge system, the sludge return system and the sludge treatment equipment are demolished or stopped, thereby lowering control demands and realizing unattended control.

### BRIEF DESCRIPTION OF THE DRAWINGS

FIG. 1 is a schematic diagram of a membrane bioreactor (MBR) in the prior art; and

FIG. 2 is a schematic diagram of a wastewater treatment system comprising a facultative-organism-adapted membrane bioreactor in accordance with one exemplary embodiment of the invention.

### DETAILED DESCRIPTION OF THE EMBODIMENTS

For further illustrating the invention, experiments detailing a method and system of wastewater treatment using a facultative-organism-adapted membrane bioreactor are described below. It should be noted that the following examples are intended to describe and not to limit the invention.

A wastewater treatment system comprises a facultative-organism-adapted membrane bioreactor. The facultative-organism-adapted membrane bioreactor comprises a reaction vessel 7, a membrane separation system 8, a water production system 9 and an aeration system 10, as shown in FIG. 2. The membrane separation system 8 is disposed in the reaction vessel 7. The membrane separation system 8 employs a microfiltration membrane or an ultrafiltration membrane. The water production system optionally adopts a suction type water production system and a gravity flow type water production system. By controlling an aeration rate of the aeration system 10, a dissolved oxygen concentration in over 50% of the reaction vessel is greater than 0 and smaller than 1.0 mg/L, a dissolved oxygen concentration is greater than 0 and smaller than 2.0 mg/L in the membrane separation system, and a dissolved oxygen concentration in the reaction vessel excluding the membrane separation system to be greater than 0 and smaller than 1.0 mg/L, and the dissolved oxygen concentration in the membrane separation system is higher than the dissolved oxygen concentration in the reaction vessel excluding the membrane separation system, so as to form a dissolved oxygen concentration gradient in the reaction vessel 7 and meanwhile flush the membrane separation system 8 by aeration.

The invention also provides an example of upgrading a common wastewater treatment system into a wastewater treatment system comprising a facultative-organism-adapted membrane bioreactor.

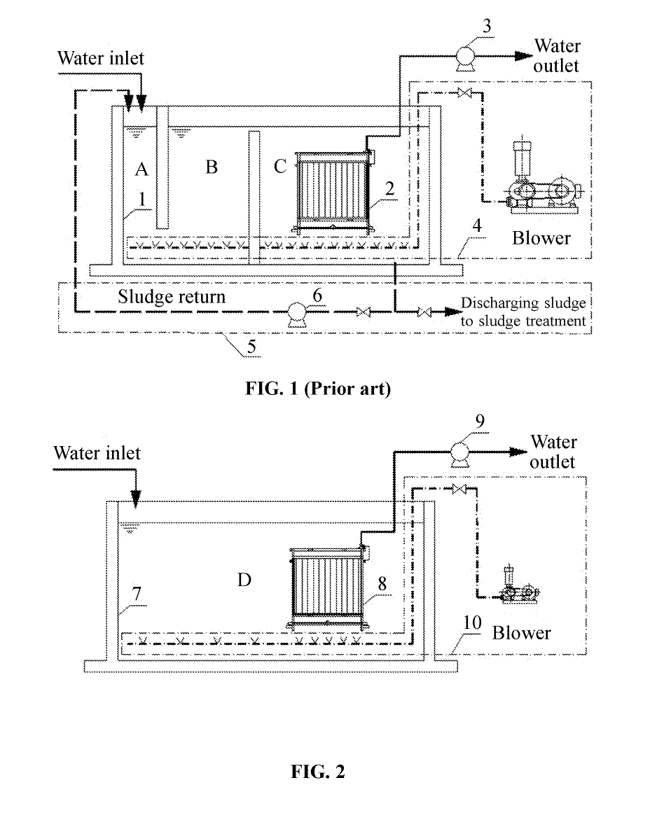

A school employed the wastewater treatment system comprising a common membrane bioreactor (MBR), with a treatment capacity of 100 t/d. A schematic diagram of the prior MBR is shown as FIG. 1. The MBR was an integrated device, comprising: a reaction pool 1, a membrane separation system 2, a water production pump 3, an aeration system 4, sludge discharge and return system 5, a sludge pump 6, and sludge treatment equipment. The reaction pool 1 was separated into a diversion zone A, an anoxic zone B, and a membrane reaction zone C. An independent aeration pipe and blower were disposed on each reaction zone. The sludge was discharged from the MBR every three days, for 15 minutes each time. Sludge in the membrane reaction zone C returned to the diversion zone A, with a return ratio of 1:1. The power consumption per unit during operation period was 0.86 kWh/t, and staffs were on duty for 24 hours at the wastewater station.

Steps to upgrade the MBR (as shown in FIG. 1) into a facultative-organism-adapted membrane bioreactor comprise:
a) demolishing the separators in the reaction vessel;
b) changing the configuration of the aeration system, and employing only one blower to aerate; and
c) demolishing the sludge discharge system, the sludge return system and sludge treatment equipment.

After the above steps, the original MBR membrane bioreactor was upgraded into a wastewater treatment system comprising a facultative-organism-adapted membrane bioreactor as shown in FIG. 2. The wastewater treatment system comprises a reaction vessel 7, a membrane separation system 8, a water production system 9 and an aeration system 10, and the reaction pool 7 was provided with a facultative membrane reaction zone D. The rated power of the blower decreased from 3.3 kWh to 1.5 kWh, and an organism system is rebuilt. The average concentration of the dissolved oxygen in the reactor was 0.72 mg/L. Zero sludge was discharged, and the power consumption per unit during operation period was 0.39 kWh/t. The wastewater station was unattended, and staffs only needed to patrol once a week.

The invention claimed is:

1. A wastewater treatment system comprising a facultative-organism-adapted membrane bioreactor, the facultative-organism-adapted membrane bioreactor comprising:
a reaction vessel;
a membrane separation system, the membrane separation system being disposed in the reaction vessel;
a water production system; and
an aeration system; wherein
the water production system communicates with the membrane separation system to pump a filtrate out of the membrane separation system; and
the aeration system is employed to aerate the reaction vessel and the membrane separation system.

2. The system of claim 1, wherein by controlling an aeration rate of the aeration system, a dissolved oxygen concentration in over 50% of the reaction vessel is greater than 0 and smaller than 1 mg/L, a dissolved oxygen concentration in the membrane separation system is greater than 0 and smaller than 2.0 mg/L, and a dissolved oxygen concentration in the reaction vessel excluding the membrane separation system is greater than 0 and smaller than 1.0 mg/L; the dissolved oxygen concentration in the membrane separation system is higher than the dissolved oxygen concentration in the reaction vessel excluding the membrane separation system.

3. The system of claim 1, wherein the water production system is a suction type water production system or a gravity flow type water production system.

4. The system of claim 1, the membrane separation system employs a microfiltration membrane or an ultrafiltration membrane.

5. A method of wastewater treatment using a facultative-organism-adapted membrane bioreactor of claim 1, the method comprising: 1) aerating the reaction vessel to enable a dissolved oxygen concentration in over 50% of the reaction vessel to be greater than 0 and smaller than 1.0 mg/L, a dissolved oxygen concentration in the membrane separation system to be greater than 0 and smaller than 2.0 mg/L, and a dissolved oxygen concentration in the reaction vessel excluding the membrane separation system to be greater than 0 and smaller than 1.0 mg/L; and 2) controlling the dissolved oxygen concentration in the membrane separation system to be higher than the dissolved oxygen concentration in the reaction vessel excluding the membrane separation system.

6. A method of upgrading a common membrane bioreactor into a facultative-organism-adapted membrane bioreactor, the common membrane bioreactor comprising a reaction vessel comprising separators and a front reaction zone, the method comprising:
a) demolishing the separators or the front reaction zone of the reaction vessel;
b) cutting down an aeration rate of a blower or reducing the arrangement of aeration pipes of an aeration system to enable a dissolved oxygen concentration in over 50% of the reaction vessel to be greater than 0 and smaller than 1.0 mg/L, a dissolved oxygen concentration in the reaction vessel excluding the membrane separation system to be greater than 0 and smaller than 2.0 mg/L, and a dissolved oxygen concentration in the reaction vessel excluding the membrane separation system to be greater than 0 and smaller than 1.0 mg/L; and controlling the dissolved oxygen concentration in the membrane separation system to be higher than the dissolved oxygen concentration in the reaction vessel excluding the membrane separation system; and
c) demolishing or stopping a sludge discharge system, a sludge return system and sludge treatment equipment.
